(19) United States
(12) Patent Application Publication
(10) Pub. No.: US 2012/0219895 A1
(43) Pub. Date: Aug. 30, 2012

(54) POLYESTER STYRENE VINYL HYBRID POLYMER LATEX FOR CHEMICALLY PRODUCED TONER

(75) Inventors: Francis L. CHUPKA, Columbia, TN (US); Akira MISAWA, Boston, MA (US)

(73) Assignee: IMAGE POLYMERS COMPANY, LLC, Andover, MA (US)

(21) Appl. No.: 13/355,254

(22) Filed: Jan. 20, 2012

Related U.S. Application Data
(60) Provisional application No. 61/446,837, filed on Feb. 25, 2011.

(51) Int. Cl. G03G 9/087

(52) U.S. Cl. 430/109.4; 430/137.17; 430/137.14

(57) ABSTRACT

A process is provided for preparing a polyester styrene vinyl hybrid polymer latex composition which may be used to prepare toner for use in electrographic applications by the emulsion aggregation process. The process includes preparing a polyester by polycondensation, preparing a solution of the polyester in a mixture of styrene and vinyl monomers, emulsifying the polyester/monomer solution, and polymerizing the emulsion via emulsion polymerization to yield a polyester styrene vinyl hybrid polymer latex composition. The latex affords excellent fixing when used in chemically produced toner made by the emulsion aggregation process.

### CROSS-REFERENCE TO RELATED APPLICATION

This application claims the benefit of U.S. provisional patent application No. 61,446,837, filed Feb. 25, 2011.

### BACKGROUND OF THE INVENTION

The present invention relates to a polyester styrene vinyl hybrid polymer latex, such as a polyester styrene acrylate polymer latex, that may be used as the binder in chemically produced toner made by the emulsion aggregation process for use in electrophotography.

Two key types of processes are used to produce electrophotographic toners. Conventional routes are mechanical grinding processes, which yield mechanically pulverized toner (MPT). More recently, methods for producing chemically produced (or prepared) toner (CPT) have been developed. CPTs have been shown to offer significant benefits, including smaller particle size (better resolution), lower energy use, better control over particle shape, and narrower particle size distribution.

There are several methods to produce CPT, including suspension polymerization, emulsion aggregation (EA), dispersion polymerization, and chemical milling.

Styrene acrylate polymers are particularly suited for an EA-CPT process because these latexes can be made directly from monomers by emulsion polymerization. A disadvantage is that emulsion polymerization of vinylic monomers (e.g., styrene and alkyl (meth)acrylates) yields high molecular weight polymers which are detrimental to good low temperature fixing. To improve fixing, high concentrations of low melting point waxes are added to the toner formulation. However, the use of high wax levels can lead to coating of toner material on the printer or copier parts (i.e., developing and fusing rollers) during the printing process.

In the conventional MPT process, polyesters have been shown to have superior low temperature fixing properties relative to styrene vinylic polymers. Therefore, polyester latexes have also been used to prepare EA-CPT. However, polyester latexes cannot be polymerized directly by emulsion polymerization. Instead, a solution of the polyester resin in a low boiling point solvent is emulsified in water, and the solvent is subsequently removed by distillation to yield the polyester emulsion.

From experience with MPTs made by conventional manufacturing processes, it is known that bimodal styrene acrylate resins which contain a low molecular weight component have good low temperature fixing properties. These resins are typically produced by solution polymerization, which is much preferred over emulsion polymerization for producing low molecular weight polymers. Polymers with number average molecular weights less than 5,000 Daltons can be produced by solution polymerization, whereas these low molecular weights cannot be achieved using emulsion polymerization. Under atmospheric conditions using aromatic solvent in a batch solution polymerization process, high concentrations of free radical initiator are required to attain these low molecular weights. However, under pressure and high temperature, these low molecular weight polymers can be produced using low concentrations of initiator. The solution polymerization process can be conducted batch-wise or continuously, as described in U.S. Pat. No. 4,963,456.

It would be desirable to develop a polyester styrene vinyl latex which could circumvent the disadvantages with fixing monomodal styrene vinyl latexes and the need for using solvents to produce polyester latexes.

### BRIEF SUMMARY OF THE INVENTION

The present invention provides a process for producing a polyester styrene vinyl hybrid polymer latex composition comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a hybrid polymer latex composition.

A polyester styrene vinyl hybrid polymer latex composition prepared by a process comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a hybrid polymer latex composition

A process for producing a chemically produced toner by emulsion aggregation according to an embodiment of the invention comprises emulsion polymerizing a polyester styrene vinyl hybrid polymer latex composition prepared by a process comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a hybrid polymer latex composition.

### DETAILED DESCRIPTION OF THE INVENTION

The present invention relates to a process for preparing a polyester styrene vinyl hybrid polymer latex composition. Such a polymer latex may be used in the production of photoelectrographic toner by an EA-CPT process. As described in more detail below, the process involves first preparing a polyester by polycondensation, followed by preparing a solution of the polyester in styrene and vinyl monomers. Subsequently, the method involves emulsifying the solution into water and polymerizing the emulsion by emulsion polymerization. The resulting polyester styrene vinyl hybrid polymer latex has distinct properties. The polyester acts as a fixing additive to improve low temperature fixing when the latex is used in a toner, whereas the high molecular weight portion of the composition, formed from emulsion polymerization of the styrene and vinyl monomers, aids hot offset resistance.

### Preparation of the Polyester

The first step of the process for producing the latex according to the invention involves preparing a polyester. The polyester is preferably prepared via stepwise polycondensation, such as between an organic diol and an organic diacid in the presence of a polycondensation catalyst at elevated temperature. It is also within the scope of the invention to utilize a diester, cyclic ester (lactone), or acid anhydride in place of the diacid.

The monomers used for the synthesis of the polyester are not particularly limited provided that the resulting polyester has the desired melting point, molecular weight, and structure (described in detail below) to impart good low temperature fixing of the final resin. For example, appropriate organic diols may be aliphatic or aromatic. Preferred aliphatic diols contain about 2 to about 36 carbon atoms, such as, for example, 1,2-ethanediol; 1,2-propanediol; 1,3-propanediol; 1,2-butanediol; 1,4-butanediol; 1,5-pentanediol; 1,6-hexanediol; 1,7-heptanediol; 1,8-octanediol; 1,9-nonanediol; 1,10-decanediol; 1,12 dodecanediol; 1,4-cyclohexanedimethanol; cyclohexanediol; diethylene glycol; bis(2-hydroxyethyl)oxide; dipropylene glycol; dibutylene glycol; and neopentyl glycol.

Exemplary aromatic diols include xylene dimethanol and alkylene oxide adducts of bis phenol A, in which the preferred alkene oxide groups are ethylene and propylene oxide with a chain length of about 1 to about 16 alkylene oxide units, preferably about 1 to about 5 alkylene oxide units.

Appropriate diacids, diesters, and acid anhydrides include saturated and unsaturated aliphatic and aromatic types. For example, exemplary aliphatic, saturated carboxylic acids (diacids) include oxalic acid, malonic acid, succinic acid, adipic acid, sebacic acid, azelaic acid, pimelic acid, suberic acid, dodecane diacid, dodecylsuccinic acid, and alicyclic diacids such as cyclohexane dicarboxylic acid. The corresponding diesters and acid anhydrides may also be used in the polycondensation reaction.

Exemplary aliphatic unsaturated carboxylic acids (diacids) include maleic acid, fumaric acid, itaconic acid, citraconic acid, glutaconic acid, and mesaconic acid. Exemplary aromatic saturated diacids include phthalic acid, isophthalic acid, terephthalic acid, trimellitic acid, pyromellitic acid, and naphthalene 2,6-dicarboxylic acid. The corresponding diesters and acid anhydrides may also be used in the polycondensation reaction. Finally, examples of cyclic esters or lactones that may be utilized include γ-butyrolactone and ε-caprolactone.

The polycondensation catalyst used to prepare the polyester may be one known in the art or to be developed for the synthesis of polyesters, including, without limitation, a tetraalkyl titanate, a dialkyl tin oxide such as dibutyl tin oxide, a tetraalkyl tin such as dibutyl tin dilaurate, a dialkyl tin oxide hydroxide such as dibutyl tin oxide hydroxide, an aluminum alkoxide, an alkyl zinc, a dialkyl zinc, a zinc oxide, a stannic oxide, and mixtures thereof.

Preferably, the polycondensation reaction to produce the polyester is performed at about 150° C. to about 250° C. in the absence of solvent (neat). The reaction is preferably performed under atmospheric pressure, but vacuum may be applied in the final stage to help remove water formed during the polyesterification and push the reaction to completion.

The melting point of the polyester is preferably low to impart good fixing. Specifically, polyesters with a maximum endothermic peak in the range of about 50° C. to about 120° C., more preferably about 55° C. to about 115° C. as measured by differential scanning calorimetry (DSC) are preferred. Also preferred are glass transition temperatures as measured by DSC of about 45° C. to about 85° C. and softening point (as depicted by Tm or T½ measured by a Shimadzu CFT500D capillary rheometer) of about 50° C. to about 110° C.

The polyester utilized in the latex composition may be either crystalline or amorphous. Most polyesters have some crystallinity (semi-crystalline), and the degree of crystallinity may be estimated using a crystallinity index. One method of determining crystallinity index is the ratio of the softening point (Tm or T½ as measured by a Shimadzu CFT500D Capillary Rheometer) to the maximum endothermic peak (melt peak) as measured by DSC. Crystalline polyesters are defined as having a crystallinity index (ratio) between 0.6 and 1.3, preferably between 0.9 and 1.2, and more preferably between 1.0 and 1.2. Amorphous polymers are defined as having a crystallinity index (ratio)>1.3.

To achieve good low temperature fixing, the molecular weight of the polyester should be reasonably low, with a number average molecular weight (Mn) of preferably about 1,000 to about 15,000 Daltons and a weight average molecular weight (Mw)) of preferably about 2,000 to about 30,000 Daltons with a polydispersity (Mw/Mn) of about 1.2 to 10 as measured by gel permeation chromatography in THF using polystyrene standards. Preferred polyesters are linear rather than cross-linked (heavily branched).

The acid value of the polyester is preferably about 1 mg KOH/g to about 40 mg KOH/g and the hydroxyl value (OHV) is preferably about 1 mg KOH/g to about 60 mg KOH/g.

### Preparation of Polyester/Styrene Vinyl Monomer Solution:

The second step of the process of the invention involves preparing a solution of the polyester by dissolving it in a mixture of vinylic monomers containing styrene and at least one vinyl monomer. Exemplary monomers include, but are not limited to, alkyl acrylates, such as methyl acrylate, ethyl acrylate, butyl acrylate, isobutyl acrylate, dodecyl acrylate, n-octyl acrylate, 2-ethylhexyl acrylate, 2-chloroethyl acrylate, phenyl acrylate, β-carboxyethyl acrylate, methyl α-chloro acrylate, methyl methacrylate, ethyl methacrylate, and butyl methacrylate; butadiene, isoprene, methacrylonitrile, acrylonitrile; vinyl ethers, such as methyl vinyl ether, vinyl isobutyl ether, and vinyl ethyl ether; vinyl esters, such as vinyl acetate, vinyl propionate, vinyl benzoate, and vinyl butyrate; vinyl ketones, such as vinyl methyl ketone, vinyl hexyl ketone, and methyl isopropenyl ketone; vinylidene halides, such as vinylidene chloride and vinylidene chloro fluoride, N-vinylindole, N-vinyl pyrrolidene, acrylic acid, methacrylic acid, acrylamide, methacrylamide, vinyl pyridine, vinyl pyrrolidone, vinyl N-methylpyridinium chloride, vinyl naphthalene, p-chlorostyrene, vinyl chloride, vinyl fluoride, ethylene, propylene, butylene, isobutylene and the like.

A preferred mixture contains predominantly styrene with an alkyl acrylate or alkyl methacrylate (containing about one to about eight carbon atoms, preferably about four carbon atoms) as a minor component, and optionally also contains a vinyl acid monomer, such as acrylic or methacrylic acid or β-carboxyethylacrylate. An exemplary mixture of monomers contains about 60-80% styrene, about 20-40% n-butyl acrylate, and about 2.5 to about 3% methacrylic acid. The monomer mixture will subsequently form a high molecular weight portion of the polyester styrene vinyl hybrid polymer upon emulsion polymerization. Accordingly, preferred vinyl polymers are styrene copolymers, such as copolymers with alkyl acrylates or alkyl methacrylates, or acidic vinyl monomers (acrylic acid, methacrylic acid, β-carboxyethylacrylate).

In order to be effective as a toner resin, the resin should have a glass transition temperature in an acceptable range, such as a Tg of about 45 to 65° C. Styrene homopolymer has a Tg of 100° C. (373K), and the Tg of styrene copolymers varies based on the comonomer used. The following equation may be used to estimate the Tg (in K) of a styrene copolymer when the molecular weight of the copolymer exceeds 10,000 to 15,000 Daltons:

1/Tg=wt % M₁/Tg₁+wt % M₂/Tg₂+ . . .

In this equation, Mₓ represents a vinyl monomer, M₁ is typically styrene, and Tgₓ represents the Tg of the homopolymer of the vinyl monomer. The homopolymer of n-butyl acrylate has a Tg of −56° C. (217K), and thus a ratio of 80:20 styrene:n-butyl acrylate will produce a copolymer having a Tg in the desired range, whereas n-butyl methacrylate homopolymer (Tg=20° C. (293K)) will require a 65-70:30-35 styrene:n-butyl methacrylate ratio to achieve the desired Tg of the copolymer.

Chain modifiers (also known as chain transfer agents) to control molecular weight during the emulsion polymerization step and thus the polymerization degree, molecular weight, and molecular weight distribution of the product latex may also be included. Preferred chain transfer agents are thiols. Exemplary chain transfer agents include, but are not limited to, mercaptans, including n-C₃₋₁₅ alkylmercaptans, such as n-propylmercaptan, n-butylmercaptan, n-amylamercaptan, n-hexylmercaptan, n-heptylmercaptan, n-octylmercaptan, n-nonylmercaptan, n-decylmercaptan, and n-dodecylmercaptan; branched alkylmercaptans, such as isopropylmercaptan, isobutylmercaptan, s-butylmercaptan, tert-butylmercaptan, cyclohexylmercaptan, tert-hexadecylmercaptan, Cert-laurylmercaptan, tert-nonylmercaptan, tert-octylmercaptan, and tert-tetradecylmercaptan; and aromatic ring-containing mercaptans, such as allylmercaptan, 3-phenylpropylmercaptan, phenylmercaptan and mercaptotriphenylmethane.

Typical examples of appropriate chain transfer agents also include, but are not limited to alkylthioglycolates, dodecanethiol, butanethiol, isooctyl-3-mercaptopropionate, 2-methyl-5-t-butyl-thiophenol, carbon tetrachloride, carbon tetrabromide, and the like. Based on the total weight of the monomers to be polymerized, the chain transfer agent is preferably present in an amount of about 0.01% to 2% by weight, preferably about 0.01 to 0.5%.

It is also within the scope of the invention to include branching or cross linking agents in the monomer mixture to control the branching structure of the vinylic hybrid polymer. Exemplary branching or cross-linking agents include aromatic divinyl compounds such as divinyl benzene and divinyl naphthalene. Diacrylate compounds bonded by alkyl chains are effective, including ethylene glycol diacrylate, 1,3-butylene glycol diacrylate, 1,4-butane diol diacrylate, 1,5-pentane diol diacrylate, 1,6-hexane diol diacrylate, neopentyl glycol diacrylate, diethylene glycol diacrylate, triethylene glycol diacrylate, tetraethylene glycol diacrylate, polyethylene 400 glycol diacrylate, polyethylene 600 glycol diacrylate, dipropylene glycol diacrylate, and analogous compounds in which the acrylate is replaced by methacrylate. Diacrylate compounds bonded by aromatic containing chains may also be included, such as polyoxyethylene(2)-2,2-bis(4-hydroxyphenyl)propane diacrylate, polyoxyethylene(4)-2,2-bis(4-hydroxyphenyl)propane diacrylate, and analogous compounds in which the diacrylate is replaced by dimethacrylate. Multifunctional acrylates or methacrylates, such as trimethyl propane triacrylate and pentaerythritol acrylate are also effective. If included, the cross-linking agent may be included in an amount of about 0.05 to 1.0% by weight. The level of crosslinking agent should be sufficient to impart toughness and provide hot offset resistance to the subsequent toner product while maintaining the thermoplastic character of the polymer and its ability to melt.

The polyester is completely soluble in the styrene and vinyl monomer mixture and can be dissolved at room temperature with gentle stirring. The concentration of polyester in monomers is preferably about 1 to about 50% by weight and most preferably about 10 to about 30% by weight.

### Emulsion of Polyester/Styrene Vinyl Monomer Solution

After preparing the polyester/monomer solution, the solution is emulsified into deionized water using typically available surfactants or combinations thereof and an appropriate high shear disperser. For example, appropriate high shear dispersing apparatuses include blenders, bead mixers, ultrasonic dispersers, and high pressure type dispersers; blenders and high pressure type dispersers are preferred, such as an IKA Labotechnik T-45 rotor-stator disperser fitted with a TP45P generator.

Preferably, a solution of water soluble surfactant in deionized water is prepared, and the polyester/monomer solution is emulsified into the surfactant solution using the disperser. It may be desirable to perform dispersing at increasing speeds, such as about 5,000 rpm for about 5 minutes and then at about 10,000 rpm for about 10 minutes. A preferred ratio of solution (organic or oil phase) to aqueous phase is about 1:4 (20% oil phase) to 3:2 (60% oil phase), more preferably about 1:1 (50% oil phase). In a preferred embodiment, equal weights of water and polyester/monomer solution are combined with about 2-6% surfactant based on water. Subsequently, the emulsion is preferably degassed and sparged with an inert gas, such as nitrogen.

Suitable surfactants can be of the anionic, non-ionic or cationic type or mixtures thereof, but preferred surfactants are anionic and non-ionic types or combinations thereof. Surfactants may be employed at any effective amount, generally at least about 0.5% based on total monomer and polymer weight and generally no more than about 10% based on the total monomer and polymer weight. Preferred amounts are about 1% to 6% based on monomer and polymer weight depending on the ratio of polyester to monomers in the organic phase, or about 2 to 6% based on water.

Examples of suitable anionic surfactants include, but are not limited to, sodium alkyl sulfates and sodium alkyl sulfonates (such as those having about 12 to 16 carbon atoms), including sodium dodecyl sulfate, sodium dodecylbenzene sulfonate, sodium dodecylnaphthalene sulfate, dialkylbenzenealkyl sulfates and sulfonates, sodium ethoxylated esters, Calsoft® (available from Pilot Chemical Co.), Dowfax® (available from Dow Chemical Co.), Neogen R and SC® (available from Kao), TaycaPower® (available from Tayca Corp.), ethoxylated phosphate ester salts, and Dextrol® (available from Ashland Chemical Co.), as well as mixtures thereof.

Examples of suitable nonionic surfactants include, but are not limited to, polyvinyl alcohol, polyacrylic acid, methyl cellulose, ethyl cellulose, hydroxyethyl cellulose, carboxyethyl cellulose, polyoxyethylene cetyl ether, polyoxyethylene lauryl ether, polyoxyethylene octyl ether, polyethylene sorbitan monolaurate, polyoxyethylene stearyl ether, polyoxyethylene nonylphenyl ether, dialkylphenoxypoly(ethylene oxy) ethanol (available from Rhone Poulenc as Igepal® and Antranox®) and Surfonic® L24-22 and L68-20 (available from Huntsman Chemical Co.), as well as mixtures thereof.

Examples of suitable cationic surfactants include, for example, dialkylbenzenealkyl ammonium chloride, lauryl trimethyl ammonium chloride, alkyl benzyl methyl ammonium chloride, alkyl benzyl dimethyl ammonium chloride, alkyl benzyl dimethyl ammonium bromide, cetyl pyridinium bromide, C_{12-C17} trimethyl ammonium bromide, halide salts of quaternized polyoxyethylalkyl amines, dodecylbenzyl trimethyl ammonium chloride, Mirapol® and Alkaquat® (available from Alkaril Chemical Co.), Sanazol® (available from Kao Corp.), as well as combinations thereof.

### Emulsion Polymerization

Finally, the polyester and vinyl monomers emulsion is polymerized by emulsion polymerization, which may be performed using any suitable process with a free radical initiator at elevated temperature. However, a semi continuous process (seed emulsion polymerization) is preferred to a batch process in order to minimize batch-to-batch variation and to obtain more consistent molecular weight and particle size.

The polymerization reactor utilized preferably includes means for stirring, heat control, emulsion addition, and inert gas sparging. The typical mixing rate for a 1 liter reactor is about 150 to 220 rpm, preferably about 190 to 200 rpm.

The seed polymerization process involves first preparing an initiator solution in deionized water. A polymerization reactor is charged with an aqueous surfactant solution and the temperature is elevated to about 65 to 95° C. with stirring under a nitrogen atmosphere. The surfactant solution may be identical to or different than that used to form the monomer/polyester emulsion; preferred surfactants are described above. The amount of surfactant solution charged to the reactor is calculated to afford the desired final solids content in the latex. Typical solids contents of about 20 to 60%, such as about 30 to 35%, are preferred.

Subsequently, the process involves adding a portion (typically about 3-10%) of the polyester/monomer emulsion to the surfactant solution, then adding the initiator solution and allowing it to polymerize and form the seed polymer. The contents are heated to the desired polymerization temperature, preferably about 50-90° C., depending on the initiator used. Typically, a temperature of about 70-75° C. is employed.

To complete the emulsion polymerization, the remainder of the monomer/polyester emulsion is added over an extended time period (such as about two to six hours), followed by a post polymerization period of about two hours conducted at the polymerization temperature to complete the conversion of monomers.

Any suitable initiator or mixture of initiators may be utilized in the emulsion polymerization according to the invention. Preferably, the initiator is selected from various known free radical polymerization initiators and can be any free radical polymerization initiator capable of initiating a free radical polymerization process or mixtures thereof, typically free radical initiators capable of providing free radical species upon heating to above about 30° C. Appropriate initiators include both water soluble free radical initiators that are traditionally used in emulsion polymerization reactions, as well as oil soluble free radical initiators.

Examples of suitable free radical initiators include, but are not limited to, peroxides, such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzyl peroxide, lauroyl peroxide, diisopropyl peroxycarbonate, tetralin hydroperoxide, 1-phenyl-2-methylpropyl-1-hydro-peroxide, tert-butylhydroperoxide, ammonium persulfate, sodium persulfate, potassium persulfate, pertriphenylacetate, tert-butyl performate, tert-butyl peracetate, tert-butyl permethoxyacetate, and tert-butylper-N-(3-toluyl)carbamate; azo compounds such as 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-amidinopropane)-nitrate, 2,2′-azobisisobutane, 2,2′-azobisisobutylamide, 2,2′-azobisisobutane, 2,2′-azobisiobutyronitrile, methyl 2,2′-azobis-2-methylpropionate, 2,2′-dichloro-2,2′azobisbutane, 2,2′-azobis-2-methbutyronitrile, dimethyl 2,2′-azobisisobutylrate, 1,1′-azobis (sodium-methylbutyronitrile-3-sulfonate), 2-(4-methylphenylazo)-methylmalonodi-nitrile, 4-4′-azobis-4-cyanovalerate acid, 2,5-dihydroxymethylphenylazo-2-methylmalonodinitrile, (4-bromophenylazo)-2-allylmalonodinitrile, 2,2′-azobismethylvaleronitrile, dimethyl 4,4′-azobis-4-cyanovalerate, 2,2′-azobis-2,4-dimethylvalcronitrile, 1,1′-azobiscyclohexanenitrile, 2.2′-azobis-2-propylbutyronitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenylazodiphenylmethane, phenylazotriphenylmethane, 4-nitrophenylazotriphenylmethane, 1′-azobis-2,2′-diphenylethane, poly(bisphenol A-4,4′-azobis-4-cyanopentano-ate), and poly(tetraethylene glycol-2,2′-azobisisobutyrate); and 1,4-bis(pentaethylene)-2-tetrazene, 1,4-dimethyoxycarbonyl-1,4-diphenyl-1-2-tetrazene; and mixture thereof.

Preferred free radical initiators include, for example, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, sodium persulfate, potassium persulfate, diisopropyl peroxycarbonate, etc. Most preferred are sodium, potassium, and ammonium persulfate salts.

Based on total weight of the monomers to be polymerized, the initiator may generally be present in an amount of about 0.1% to about 5%, preferably about 0.4% to about 4%, more preferably about 0.5% to about 3%, although it may be present in greater or lesser amounts.

### Coagulation

Following polymerization, the latex may be coagulated to isolate the bimodal polymer for characterization. Coagulating agents, including multivalent salts, such as aluminum sulfate, or acids, such as hydrochloric acid, will coagulate the latex. For example, the coagulating agent may be stirred with the finished latex (by hand, if necessary, due to the increasing viscosity of the mixture) to complete coagulation. Appropriate coagulation temperatures are about 20 to 50° C. Subsequently, isolation of the solid bimodal polymer may be accomplished by centrifugation, several water washes, and optionally filtration and vacuum drying.

### Analysis Test Methods

The polymer may be characterized by standard procedures used to analyze toner resins, including glass transition temperature, melt index (melt flow), flow test, acid number, and molecular weight. For example, glass transition temperature (T_{g}) may be measured using Differential Scanning calorimetry using a Model Q10 calorimeter obtained from TA Instruments (New Castle, Del.). Typical conditions include the use of an indium standard and a heating rate of 10° C./minute (second heat).

Melt index or melt flow according to ASTM Standard 1238 may be measured using a Tinius-Olsen (Willow Grove, Pa.) Extrusion Plastograph Model 993a. Typical conditions include a load of 2.16 Kg and a temperature of 125° C. or 150° C.

In a flowtest, two parameters are determined: Tm (T_{1/2}, melting point by the ½ method), and Ti (Tfb, beginning flow by the ½ method). Flowtest may be measured using a Shimadzu Capillary Rheometer, Model CFT 500D (Shimadzu Instrument Co., Columbia, Md.). Typical conditions include a load of 20 Kg and a heating rate of 6° C./min.

Acid Number is determined as described in ASTM D-1639-83.

Finally, molecular weight of the polymers is determined using gel permeation chromatography. A typical apparatus includes a Waters (Waters Corp., Milford, Mass.) 600E Systems Controller, 610E Fluid Unit, 410 Differential Refractometer, and 717 Plus Auto Sampler using as columns Waters Styragel Cluster containing Styragel HR1 and Styragel HMW6E and a column temperature of 40° C. Molecular weights are determined using a mixture of polystyrene standards having molecular weights from 500 to 8MM Daltons.

### Polymer Properties

The hybrid polymer composition can exhibit a monomodal or multimodal spectrum when the molecular weight is measured by gel permeation chromatography. A multimodal (typically bimodal) polymer composition may contain distinct low and high molecular weight portions. The low molecular weight portion is typically a linear polymer which consists mainly of the polyester component, but may contain some low molecular weight styrene vinylic polymers produced by emulsion polymerization. The high molecular weight component consists of the styrene vinylic polymer produced by emulsion polymerization, and may be linear, branched, or cross-linked. A THF soluble portion of the overall hybrid composition preferably has a number average molecular weight (Mn) as measured by gel permeation chromatography of about 15,000 to 100,000 Daltons, a weight average molecular weight (Mw) of about 200,000 to 1,400,000 Daltons, and a polydispersity (Mw/Mn) of about 5 to 30.

If the polymer is bimodal, a THF soluble portion of the low molecular weight portion preferably has a number average molecular weight (Mn) as measured by gel permeation chromatography of about 5,000 Daltons to 70,000 Daltons, a weight average molecular weight (Mw) of about 6,000 Daltons to 140,000 Daltons, and a polydispersity (Mw/Mn) of about 1.1 to 5.

A THF soluble portion of the high molecular weight component preferably has a number average molecular weight (Mn) as measured by gel permeation chromatography of about 1,700,000 to 4,500,00 Daltons, a weight average molecular weight (Mw) of about 2,000,000 to 5,200,000 Daltons, and a polydispersity (Mw/Mn) of about 1.1 to 3.

Preferred properties of the bimodal polymers include Tg from about 50° to about 65° C., acid number of about 1 to about 30 mg KOH/g polymer, Tm of about 106° to about 140° C., and Ti of about 88 to about 105° C.

Embodiments of the invention will now be described in conjunction with the following, non-limiting examples.

### EXAMPLE 1

### Preparation of Crystalline Polyester Resin (PES-1) from Succinic Acid, Adipic Acid, and 1,4-Butane Diol

A one-liter resin kettle equipped with a turbine agitator, Dean Stark trap equipped with a condenser, and a nitrogen/vacuum inlet port was charged with 221.4 g (1.875 moles) of succinic acid, 146.1 g (0.625 moles) of adipic acid, 225.3 g (2.5 moles) of 1,4-butane diol, and 1.54 g (0.3 wt. % on total monomers) of dibutyl tin oxide. The reactor was heated to 160° C. under nitrogen and held for 5 hours with stirring. The temperature was increased to 200° C. and held for 1 hour with stirring under atmospheric pressure. The pressure was reduced to 30 mmHg and the contents held at 200° C. with stirring for 1 hour. The properties of the resulting polyester are compiled in Table 1. Table 1 also illustrates the properties of four commercially available polyesters (PES-3, -4, -5, -6) for comparison.

### EXAMPLE 2

### Preparation of Crystalline Polyester Resin (PES-2) from Fumaric Acid, Adipic Acid, and 1,4- Butane Diol

The procedure used was identical to that described in Example 1 except the monomer charge consisted of 217.6 g (1.875 moles) of fumaric acid, 91.3 g (0.625 moles) of adipic acid, 236.6 g (2.625 moles) of 1,4-butane diol, 1.54 g (0.3 wt. % on total monomers) of hydroquinone, and 1.54 g (0.3 wt.% on total monomers) of dibutyl tin oxide. The properties of the polyester (PES-2) are compiled in Table 1.

TABLE 1
Polyester Properties

| | | DSC | | | | | | |
|---|---|---|---|---|---|---|---|---|
| | | Melt | Softening | Melt Index | | Hydroxyl | | |
| | Tg | Peak | Point, | @ 2.16 Kg | Acid Value | Value | Mw | Mn |
| Designation | (° C.) | (° C.) | Tm (° C.) | (g/10 min | (mgKOH/g) | (mgKOH/g) | (E4) | (E4) |
| PES-1 | 67.9 | 93.5 | 83.3 | 1070@150° C. | 26.4 | 1.1 | na | na |
| PES-2 | 84.3 | 113 | 97 | na | 4.5 | 6.0 | na | na |
| PES-3 | 61.4 | 70.2 | 79 | na | 0.8 | 45.1 | 1.99 | 0.99 |
| PES-4 | 52 | 59.9 | 91.6 | 21.4@105° C.) | 21.6 | 20 | 1.26 | 0.54 |
| PES-5 | 47.1 | 59.2 | 61.6 | 1080@150° C. | 0.3 | 22.6 | 1.75 | 1.35 |
| PES-6 | 48.8 | 56 | 70.8 | 12.8@150° C. | 0.4 | 6.0 | 7.86 | 5.37 |

PES 1: Example 1. Polymer of succinic acid, adipic acid, and 1,4-butane diol
PES-2: Example 2. Polymer of fumaric acid, adipic acid, and 1,4-butane diol
PES-3: poly (hexylene dodecanoate); Bayer Material Science LLC
PES-4: Polymer of propoxylated bis phenol A, isophthalic acid, and adipic acid; Hexion Specialty Chemical Co.
PES-5: poly (caprolactone); Solvay Interox Ltd.
PES-6: poly (caprolactone); Solvay Interox Ltd.

### EXAMPLE 3

### Preparation of a Polyester Poly (Styrene Acrylate) Hybrid Latex

The following procedure describes the preparation of a latex containing 20% of PES-4, an amorphous, saturated polyester.

A solution of PES-4 in vinylic monomers was prepared by charging a 1 liter blending flask equipped with a paddle stirrer with 176.2 g styrene, 57.8 g n-butyl acrylate, 6.0 g methacrylic acid, 0.72 g divinyl benzene, and 0.0.06 g of 2-ethylhexylthioglycolate. PES-4 (60.0 g) (described in Table 1) was added portion-wise with stirring at room temperature. The mixture was stirred for 1 hour at 150 rpm or until the entire polymer was dissolved in the monomers.

A solution of 6.0 g of sodium C12-16 alkyl benzene sulfonate (Calsoft F-90, Pilot Chemical Co.) and 13.4 g of ethoxylated phosphate ester (45% active, Dextrol OC-180, Ashland

Chemical Co.) in 300 g deionized water was mixed in a 2 liter blending flask equipped with a IKA Labortechnik rotor-stator mixer fitted with a TP45G generator. The polyester/monomer solution was slowly added to the aqueous surfactant phase and the phases blended for 1 minute at 200 rpm, then emulsified at 5,000 rpm for 15 minutes, and finished at 10,000 rpm for 5 minutes. The high shear caused a temperature increase which was not allowed to exceed 50° C. The emulsion was degassed with a nitrogen sparge for 10 minutes.

A 1 liter polymerization reactor equipped with a paddle stirrer, heat controller/mantle, condenser, nitrogen inlet/outlet, and condenser was charged with 6.0 g of sodium C12-16 alkyl benzene sulfonate, 13.4 g of the ethoxylated phosphate ester, and 300 g of deionized water. This aqueous phase was stirred and degassed by sparging with nitrogen as the temperature was increased to 75° C. Subsequently, 5% (30 g) of the polyester/monomer emulsion was added with stirring followed by the addition of an initiator solution containing 3.6 g of potassium persulfate in 20 g water. The reactants were allowed to polymerize for 15 minutes at 75° C. to form the seed polymer; after which time the remainder of the polyester/monomer emulsion was added over a 3 hour period. The mixture was then allowed to finish by stirring for 2 hours at 75° C.

Less than 1 g of coagulum was observed during the polymerization. The latex shelf life was excellent.

The latex was coagulated in order to characterize the polymer. Aluminum sulfate hydrate (3.0 g) was added to 200 g of latex and the mixture stirred at room temperature for 10 minutes. The coagulated mix was heated slowly with stirring to 70° C.; then cooled to room temperature and centrifuged at 3,000 rpm for 10 minutes. The solid polymer was separated from the aqueous layer by decanting off the water. The polymer was washed three times with water using the same procedure, filtered from the final washing step, and then dried in a vacuum oven maintained at 50° C./30 mm Hg for 8 hours.

The polymer composition made under these conditions exhibited the properties shown in Table 2.

TABLE 2

| | | | | | Acid Number |
|---|---|---|---|---|---|
| | | Melt Index | | | (mg KOH/g |
| | Tg (° C.) | (125° C./2.16 Kg) | Tm (° C.) | Ti (° C.) | polymer |
| Ex. 3 | 48.6 | <1 | 126.8 | 86.5 | 26.8 |
| Ex. 4 | 44.4 | 4.3 | 113.9 | 79.5 | 20.0 |

### EXAMPLE 4

A latex containing 20% of PES-5, low molecular weight, crystalline, saturated polyester was prepared using the process described in Example 3, except that PES-5 (Table 1) was used in place of PES-4.

The latex was coagulated as described in Example 3, and exhibited the properties shown in Table 2. The shelf life of the polymer was excellent.

### EXAMPLE 5

A latex containing 20% of PES-6, low molecular weight, crystalline, saturated polyester was prepared using the process described in Example 3, except that PES-6 (Table 1) was used in place of PES-4.

The emulsion exhibited instability during the polymerization stage, and a large amount of coagulum (>60 g) was formed. The latex was not coagulated for polymer characterization.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for producing a polyester styrene vinyl hybrid polymer latex composition comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a hybrid latex composition.

2. The process according to claim 1, wherein the polycondensation is performed at an elevated temperature using a polycondensation catalyst.

3. The process according to claim 2, wherein the elevated temperature is about 150° C. to about 250° C.

4. The method according to claim 2, wherein polycondensation catalyst is selected from the group consisting of a tetraalkyl titanate, a dialkyl tin oxide, a tetraalkyl tin, a dialkyl tin oxide hydroxide, an aluminum alkoxide, an alkyl zinc, a dialkyl zinc, a zinc oxide, a stannic oxide, and mixtures thereof.

5. The process according to claim 1, wherein the organic diol is an aliphatic diol having about 2 to about 26 carbon atoms.

6. The process according to claim 1, wherein the organic diol is an aromatic diol selected from the group consisting of xylene dimethanol and an alkylene oxide adduct of bis phenol A having about 1 to about 16 alkylene oxide units.

7. The process according to claim 1, wherein the solution in step (b) comprises about 1 to 50 wt. % polyester.

8. The process according to claim 7, wherein the solution in step (b) comprises about 10 to 30 wt. % low molecular weight styrene polymer.

9. The process according to claim 1, wherein step (a) comprises polycondensation of an organic diol with an aliphatic saturated compound selected from the group consisting of oxalic acid, malonic acid, succinic acid, adipic acid, sebacic acid, azelaic acid, pimelic acid, suberic acid, dodecane diacid, dodecylsuccinic acid, a cyclohexane dicarboxylic acid, and esters and anhydrides thereof.

10. The process according to claim 1, wherein step (a) comprises polycondensation of an organic diol with an aromatic compound selected from the group consisting of phthalic acid, isophthalic acid, terephthalic acid, trimellitic acid, pyromellitic acid, naphthalene 2,6-dicarboxylic acid, and anhydrides and esters thereof.

11. The process according to claim 1, wherein step (a) comprises polycondensation of an organic diol with a cyclic ester selected from the group consisting of γ-butyrolactone and ε-caprolactone.

12. The process according to claim 1, wherein step (a) comprises polycondensation of an organic diol with an aliphatic unsaturated compound selected from the group consisting of maleic acid, fumaric acid, itaconic acid, citraconic acid, glutaconic acid, mesaconic acid, and esters and anhydrides thereof.

13. The process according to claim 1, wherein the polyester has a number average molecular weight (Mn) as measured by gel permeation chromatography of about 1,000 to 15,000 Daltons.

14. The process according to claim 1, wherein the polyester has a weight average molecular weight (Mw) as measured by gel permeation chromatography of about 2,000 to 30,000 Daltons.

15. The process according to claim 1, wherein the solution in step (b) further comprises a branching agent.

16. The process according to claim 15, wherein the branching agent comprises a multifunctional vinyl compound.

17. The process according to claim 1, wherein the solution in step (b) further comprises a chain modifier.

18. The process according to claim 17, wherein the chain modifier comprises a thiol.

19. The process according to claim 1, wherein a THF soluble portion of the bimodal polyester styrene vinyl hybrid polymer has a number average molecular weight as measured by gel permeation chromatography of about 15,000 to 100,000 Daltons, a weight average molecular weight of about 200,000 to 1,400,000 and a polydispersity of about 5 to 30.

20. The process according to claim 1, wherein the polyester styrene vinyl hybrid polymer comprises a high molecular weight component and a low molecular weight component, and wherein a THF soluble portion of the high molecular weight component has a number average molecular weight as measured by gel permeation chromatography of about 1,700,000 to 4,500,000 Daltons, a weight average molecular weight of about 2,000,000 to 5,200,000, and a polydispersity of about 1.1 to 3.

21. The process according to claim 1, wherein step (c) comprises forming an emulsion having a ratio of solution to water of about 1:4 to 3:2.

22. The process according to claim 1, wherein step (c) comprises forming the emulsion using a water soluble surfactant selected from the group consisting of an anionic surfactant, a nonionic surfactant, a cationic surfactant, and mixtures thereof.

23. The process according to claim 1, wherein the polymerization in step (d) is performed using a free radical initiator.

24. The process according to claim 23, wherein the free radical initiator comprises a sodium, potassium, or ammonium persulfate salt.

25. The process according to claim 1, wherein the polymerization in step (d) is performed at about 50 to 90° C.

26. The process according to claim 1, wherein the mixture containing styrene and at least one vinyl monomer comprises at least one selected from the group consisting of an alkyl acrylate and an alkyl methacrylate.

27. The process according to claim 26, wherein the mixture further comprises at least one vinyl acidic monomer selected from the group consisting of acrylic acid, methacrylic acid, and β-carboxyethylacrylate.

28. A polyester styrene vinyl hybrid polymer latex composition prepared by a process comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a hybrid latex composition.

29. A process for producing a chemically produced toner by emulsion aggregation comprising emulsion polymerizing a polyester styrene vinyl hybrid polymer latex composition prepared by a process comprising:
(a) preparing a polyester by polycondensation of an organic diol with a compound selected from the group consisting of a diacid, a diester, a cyclic ester, and an acid anhydride;
(b) preparing a solution of the polyester in a mixture containing styrene and at least one vinyl monomer;
(c) emulsifying the solution in water to form an emulsion; and
(d) polymerizing the emulsion using emulsion polymerization to form a bimodal molecular weight latex composition.
